(19) United States
(12) Patent Application Publication
(10) Pub. No.: US 2009/0328086 A1
(43) Pub. Date: Dec. 31, 2009

(54) Apparatus for Monitoring Use Status of Image Apparatus, Method of Monitoring External Connection Apparatus and Television Receiving Apparatus

(75) Inventor: Shingo Yanagimoto, Fukaya-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/476,972

(22) Filed: Jun. 2, 2009

(30) Foreign Application Priority Data
Jun. 27, 2008 (JP) 2008-169082

(51) Int. Cl. H04N 7/16

(52) U.S. Cl. 725/9

(57) ABSTRACT

According to the present invention, for example a TV receiver can be connected to a game apparatus, for example. The game apparatus outputs at least image data. The TV receiver outputs an image of the image data to a display module. A restriction information storage module, which stores operating time or restriction information about operating contents of the game apparatus, is provided in the TV receiver. An operation monitoring module monitors the operating time or the operating contents based on the restriction information. A management module announces that the operating time or the operating contents become restriction conditions during the monitoring of the operation monitoring module.

### CROSS-REFERENCE TO RELATED APPLICATIONS

This application is based upon and claims the benefit of priority from Japanese Patent Application No. 2008-169082, filed Jun. 27, 2008, the entire contents of which are incorporated herein by reference.

### BACKGROUND

1. Field

One embodiment of the invention relates to an apparatus for monitoring a use status of an image apparatus, a method of monitoring an external connection apparatus and a television receiving apparatus. When a game device is connected to a television receiving apparatus, a use status of the game device is monitored so that a warning is provided to a user.

2. Description of the Related Art

In recent years, high definition multimedia interface (HDMI) is used so that a television receiving apparatus and a plurality of audio visual (AV) devices (for example, video device, audio device, game device or DVD recorder) are connected. HDMI adopts EDID (Extended Digital Contents Protection) for authentication between devices, and CEC (Consumer Electronics Control) is adopted for connection of a control system for the entire system. For example, in Jpn. Pat. Appln. KOKAI Publication No. 2008-35190, a plurality of AV devices are connected to a television receiver via HDMI. A CEC command which is adopted in the HDMI standard is used so that physical addresses are allocated to the AV devices and connected states of external connection devices are managed. In this television receiver, names of a plurality of external connection devices can be displayed.

Conventionally, when a plurality of external connection devices are connected to a television receiver, the external connection devices can be connected easily by using an HDMI cable without complex wiring.

However, although conventionally the connected states of the external connection devices can be confirmed, a user can not impose any restrictions on the external connection devices. Since conditions for restricting external connection devices cannot be changed, users cannot impose further restrictions or arbitrarily change any of the conditions.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a diagram illustrating a block constitution of a television receiving apparatus according to one embodiment of the present invention;

FIG. 2 is a diagram illustrating a constitutional example of an HDMI signal processing module 20 in FIG. 1;

FIG. 3 is a flow chart illustrating an operation at the time when a setting screen display module 242 of FIG. 2 is actuated and restriction information is stored by using the setting screen;

FIG. 4 is a diagram illustrating an example of the setting screen;

FIG. 5 is an explanatory diagram illustrating a state when a warning text is set as restriction information and the usage time of a game device has been exceeded;

FIG. 6 is a flow chart further illustrating an operating example of the apparatus according to the present invention; and

FIG. 7 is a diagram illustrating a constitutional example of the game device according to the present invention.

### DETAILED DESCRIPTION

Various embodiments according to the invention will be described hereinafter with reference to the accompanying drawings.

One embodiment of the present invention provides a use status monitoring apparatus, a use status monitoring method and a television receiving apparatus in which a usage restriction can be set for an external connection device and a user of the external connection device can be arbitrarily managed.

In the embodiment of the present invention which solves the above problem, a first apparatus, for example a TV receiver, can be connected to a second apparatus, for example a game apparatus. The second apparatus outputs at least image data. The first apparatus is connected to the second apparatus, and outputs an image of the image data to a display module. A restriction information storage module, which stores operating time or restriction information about operating contents of the second apparatus, is provided in the first apparatus. Further, an operation monitoring module and a management module are provided. The operation monitoring module monitors the operating time or the operating contents based on the restriction information. The management module announces that the operating time or the operating contents become restriction conditions during the monitoring of the operation monitoring module.

According to the above countermeasure, a user of the second apparatus is arbitrarily managed based on the restriction information about the operating contents or the operating time of the second apparatus to be externally connected.

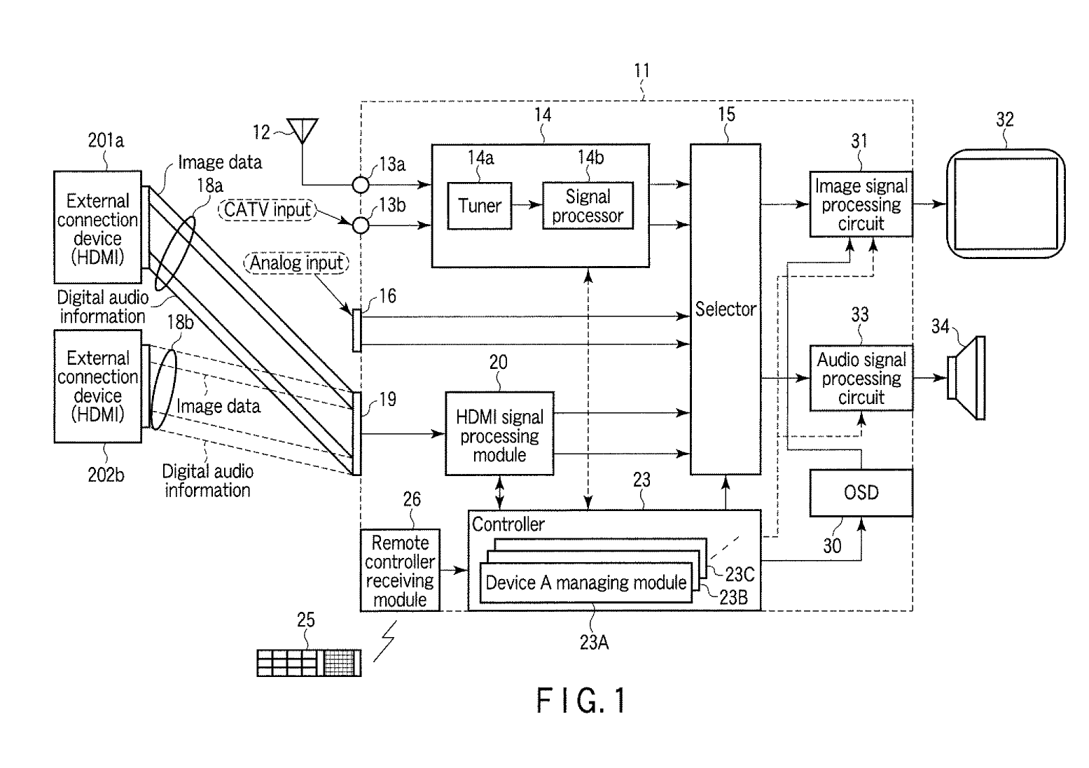

The embodiment of the present invention will be described in more detail below with reference to the drawings. FIG. 1 illustrates a television receiving apparatus 11 according to one embodiment of the present invention. The television receiving apparatus 11 has a function for reception of digital terrestrial and satellite broadcasting television signals, a function for reception of an analog image and an audio signal, and a function for reception of a digital image signal complying with the HDMI standard. In an actual device, a system which receives a digital terrestrial television broadcasting signal and a system which receives a satellite broadcasting television signal are provided independently, but they are collectively illustrated here for simplification.

The digital terrestrial and satellite broadcasting television signals are received by an antenna 12, and are supplied to a television signal processing module 14 via a TV (television) input terminal 13.

In the television signal processing module 14, a tuner module 14a takes out a predetermined channel signal from the input television broadcasting signal, a signal processor 14b restores an analog image signal and audio signal, and these signals are output to a selector 15. A signal from a CATV (Cable television) input terminal 13b, for example, can be input into the television signal processing module 14.

The analog image and audio signals are received by an AV (Audio Video) input terminal 16 and are input directly into the selector 15.

Further, a digital image signal and a digital audio signal supplied from external connection devices 201a and 201b via HDMI cable buses 18a and 18b complying with the HDMI standard are received by an HDMI connector 19. Examples of the external connection devices 201a and 201b include a game apparatus, STB (Set Top Box), DVD (Digital Video Disc) having an HDMI connector complying with the HDMI standard. Further, a personal computer may be used.

A signal from the HDMI connector. 19 is supplied to an HDMI signal processing module 20. The HDMI signal processing module 20 can restore an analog image signal and audio signal from an input digital signal complying with the HDMI standard and output them to the selector 15. Details will be described later.

The selector 15 has a function for selective switching of analog image and audio signals output from the television signal processing module 14, analog image and audio signals supplied from the AV input terminal 16 and analog image and audio signals output from the HDMI signal processing module 20 so as to derive the selected one. The analog image signal is supplied to an image signal processing circuit 31, and the analog audio signal is supplied to an audio signal processing circuit 33. An output from the image signal processing circuit 31 is supplied to a display module 32, and an output from the audio signal processing circuit 33 is supplied to a speaker system 34.

All the operations of the television signal receiving apparatus 11, including the above various receiving operations, are controlled by a controller 23. The controller 23 contains a CPU (Central Processing Unit). A receiving module 26 receives operation information transmitted from a remote controller 25. The controller 23 controls the respective modules so that the operation contents are reflected.

In this case, the controller 23 uses a memory module (not shown). The memory module mainly includes a read-only memory, a read and write memory, and a nonvolatile memory. The read-only memory stores a control program to be executed by a CPU of a controller 24. The read and write memory provides a working area for the CPU. The nonvolatile memory stores various pieces of setting information and control information.

The controller 23 outputs data such as a graphic image and a character image via an on-screen display (OSD) interface 30, and can synthesize the data with an image of the image signal processing circuit 31.

The controller 23 communicates with the external connection device, and has a device A managing module 23A, a device B managing module 23B, a device C managing module 23C, . . . which manage a plurality of external connection devices. This part is further described later.

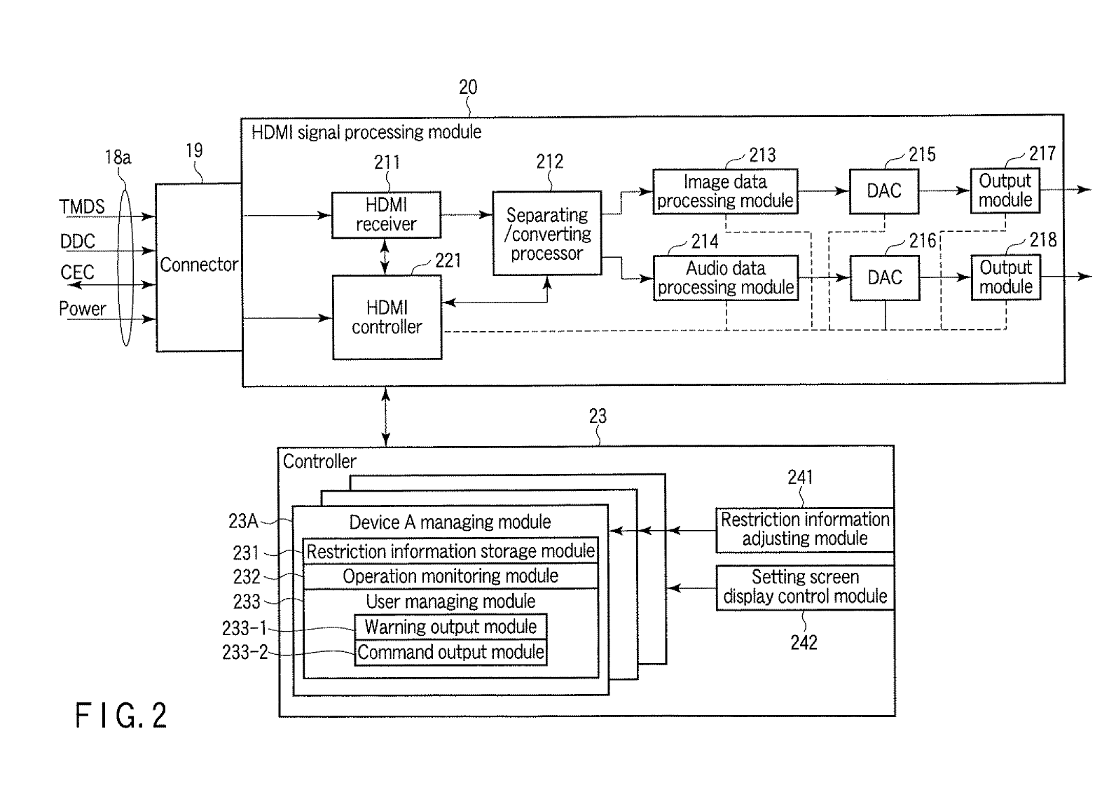

FIG. 2 illustrates the HDMI signal processing module 20 in detail. An HDMI cable 18 as a digital transmission bus complying with the HDMI standard is mainly composed of lines such as TMDS, DDC, CEC and Power.

TMDS is used for transmitting a digital image signal and a digital audio signal complying with the HDMI standard from the external connection device 201 to the HDMI connector 19 of the television signal receiving apparatus 11. TMDS can transmit a digital image signal from a DVI available device.

DDC (Consumer Electronics Control) is used for transmitting control data and a synchronous clock between the external connection devices 201a and 201b and the television signal receiving apparatus 11.

CEC is used for receiving identification information of various external connection devices and allocating physical and logical addresses to the external connection devices. The external connection devices can be controlled by the CEC command, and control information can be exchanged in bidirectional communication.

Power is used for applying a constant voltage of about 5 V from the external connection device 17 to the HDMI connector 19. That is to say, the television receiving apparatus 11 monitors a voltage level of the Power line of the HDMI connector 19 so as to determine whether the external connection device 201 is connected, namely, the Power line is used as a connection recognition signal.

A digital signal complying with the HDMI standard received via the HDMI connector 19 is supplied to an HDMI receiver 211. The HDMI receiver 211 captures a signal in synchronization with the input digital signal, and outputs the captured signal to a separating/converting processor 212. The separating/converting processor 212 separates an image component and an audio component so as to convert them into signals suitable for a display and a speaker system.

A digital image signal output from the separating/converting processor 212 is output to an image data processing module 213, and a digital audio signal is output to an audio data processing module 214. The image data processing module 213 applies MPEG (Moving Picture Experts Group) decoding processing on the input image component, and outputs the decoded output to a digital/analog converting module 215. The digital/analog converting module 215 restores an analog image signal and outputs it via an output module 217.

In the audio data processing module 214, the input audio component is subjected to a linear PCM (Pulse Code Modulation) decoding process. Some input audio components are subjected to a Dolby process, an AC3 availability process and an MPEG availability process so as to be decoded depending on attributes of the audio components. An output from the audio data processing module 214 is converted into an analog audio signal by the digital/analog converting module 216, so as to be output via the output module 218.

The HDMI signal processing module 20 contains an HDMI controller 221. The HDMI controller 221 contains a microcomputer or the like, and can reflect a command from the controller 23 in the respective functions in the HDMI signal processing module 20. The HDMI controller 221 analyzes control data sent via DDC, and can reflect the analyzed result in the respective functions in the HDMI signal processing module 20.

When detecting a change in preset data in the received digital signal, the HDMI controller 221 outputs a detection signal to an audio mute control module (not shown). The HDMI controller 221 monitors a voltage level of Power of the HDMI connector 19, and when the voltage level is changed, the HDMI controller 221 detects that the HDMI connector 19 is inserted or removed. The HDMI controller 221 outputs the detected signal to the audio mute control module (not shown). The audio mute control module outputs a mute signal to the digital/analog converting module 216 and the output module 218 with the detection signal being supplied from the HDMI receiver 211 or the detection signal being supplied from the HDMI controller 221.

A function for managing the plurality of external connection devices is provided in the controller 23. FIG. 2 illustrates the device A managing module 23A. The device A managing module 23A is provided with a restriction information storage module 231 for the use of the device A. An operation monitoring module 232 which monitors the operating time or the operating contents of the device A based on restriction information is provided. A user managing module 233 is provided. The user managing module 233 gives a message to a user when the operating time or the operating contents of the device A are restricted by the monitoring of the operation monitoring module 232.

When the device A is used for a period of time that exceeds the preset time limit, the user managing module 233 informs the user about the restriction information via the display module 32, for example. Various kinds of message contents are present as described above. The user managing module 233 may include a warning output module 233-1 for sounding a warning, and a command output module 233-2.

The controller 23 may be provided with a restriction information adjusting module 241 which changes or corrects the restriction information stored in the restriction information storage module 231. Further, a setting screen display control module 242 which displays a setting screen for changing or correcting the restriction information may be provided.

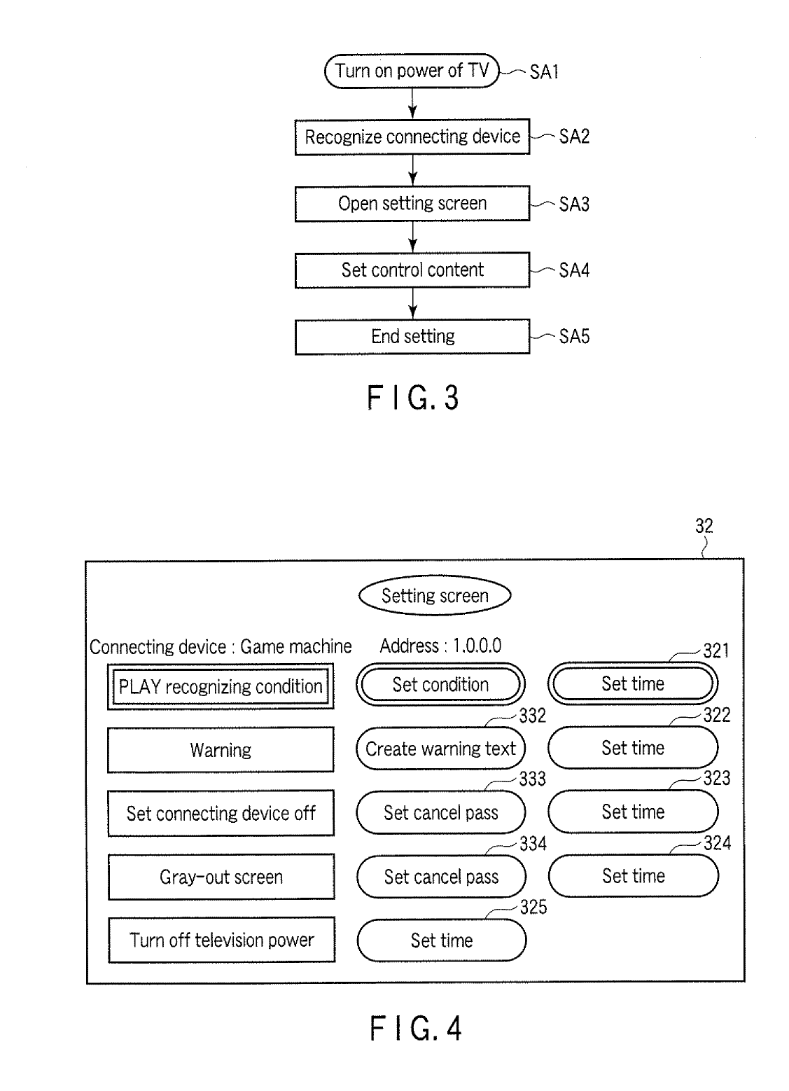

FIG. 3 is a flow chart illustrating an operation at the time when the setting screen display control module 242 is actuated and the restriction information is stored by using the setting screen. FIG. 4 illustrates an example of the setting screen.

With reference to FIG. 3, when the television receiving apparatus 11 is turned on, a connecting device is recognized (Steps SA1 and SA2). When a user selects and determines an item “setting screen” via a menu screen, the setting screen shown in FIG. 4 is displayed on the display module 23.

Control contents are set by using the setting screen (step SA4). At this time, various pieces of restriction information are stored in the restriction information storage module 231. The setting is ended by selecting and determining a display button indicating “end setting” on the menu screen via a cursor (step SA5).

In FIG. 4, as a name “AAAA” of the connecting device, in this example “game device” is displayed on the setting screen. An address allocated to the game device is also displayed.

The user can input restriction information and warning information here. When the game device is managed, start of use of the game device should be recognized. For this reason, items “PLAY recognizing condition”, “condition setting” and “setting time” are present. A condition of a state recognized as the PLAY start of the game device can be input by using “setting time”. For example, a cursor is moved to a position of the item “set time” 321 by a remote control operation, and a determining operation is performed. As a result, a time input screen appears, and for example, a start button is operated so that “PLAY” is started three minutes later. When the operating state of the game device is detected, the PLAY state of the game device can be recognized without any particular time setting.

When game play allowed time passes, a warning text displayed, for example, on the display module 32 can be created. When this warning text is created, the cursor is moved to a position of an item “warning text” 332 by remote control operation, and a determining operation is performed. As a result, a warning text input screen appears so that the warning text can be input. The warning text can be input by a keyboard or an input key of the remote controller. The content of the warning text may be preset by default according to the connecting device.

An item “set time” 322 is selected so that a time input screen is displayed, and the time between the start of a game and display of the warning text can be determined.

The setting can be made so that the connecting device is turned off according to a certain condition. As the condition, a setting time equal to the period of time since start of the game is utilized. When the setting time is input, an item “set time” 323 is selected so that the time input screen is displayed, and the setting time can be input and determined. In this case, a cancel password for avoiding turning-off of the connecting device (hereinafter, abbreviated as cancel pass) can be set. In this case, the cursor is moved so as to select an item “set cancel pass” 333, and a cancel pass input screen is displayed, so that the cancel pass can be input.

For example, a screen may be set to change color to gray so that it becomes gradually difficult to view the screen on the display module of the television receiving apparatus, according to conditions. With such a constitution, the user can be urged to end the game. As the condition, a setting time equal to the period of time since start of the game is used. When the setting time is input, an item “set time” 324 is selected so that the time input screen is displayed and the setting time can be input to be determined. In this case, the cancel pass for avoiding the difficulty in viewing the display on the screen may be set. In this case, a user moves a cursor so as to select an item “set cancel pass” 334, and the cancel pass input screen is displayed so that the cancel pass is input.

When an image quality is changed in the television receiving apparatus, the resolution may be changed sequentially, for example; 1080P, 1080i, 720p, 480p and 480i. In another method, an audio output may be gradually reduced or turned off. Further, a change in the image quality may be synchronized with a change in the audio so that the image quality is changed. Further, the image quality may be automatically brought into a still reproduction state or a mosaic state.

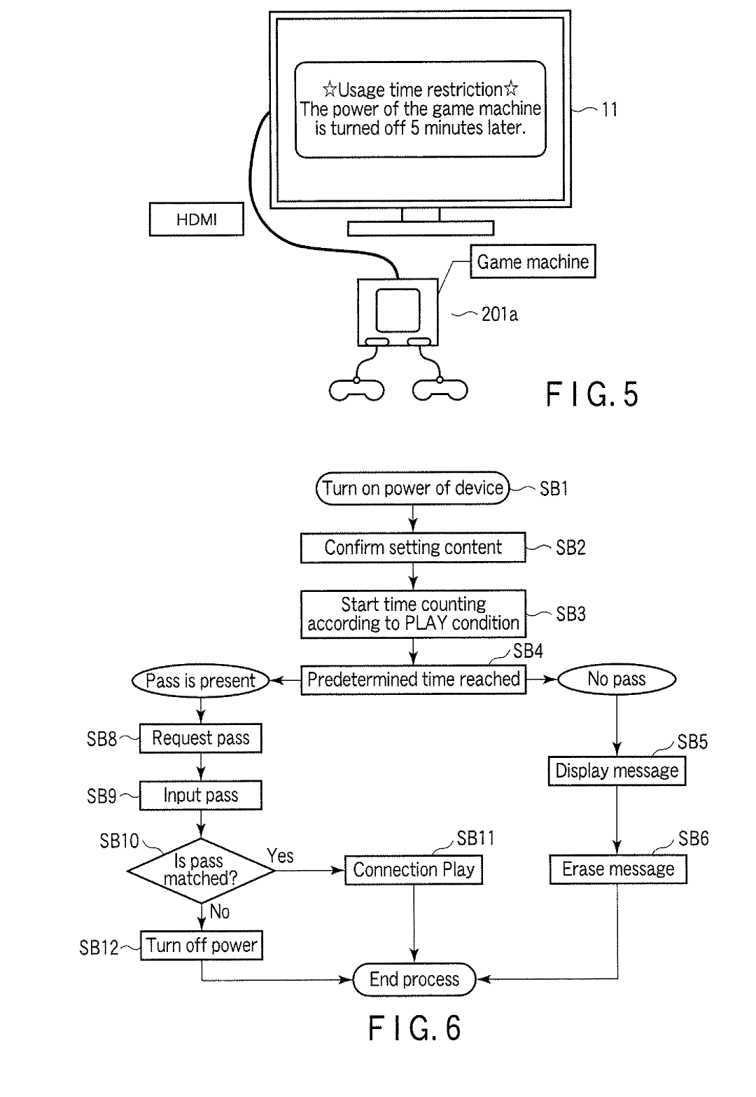

FIG. 5 illustrates a state that a warning text is set as the restriction information and the usage time of a game device 201a has been exceeded. The warning text includes, for example, “use start time restriction”, and “the power of the game machine will be turned off in 5 minutes”. At this time, as the restriction information, “warning” and “set connecting device off” in FIG. 4 are set.

An operation in the case where an item “cancel pass” 333 in FIG. 4 is set will be described with reference to FIG. 6. In FIG. 6, the device is turned on, and the set contents of the restriction information storage module 231 are confirmed (steps SB1 and SB2). Time measurement is started according to PLAY conditions (step SB3). When the setting time since the start of the game has been exceeded, a message indicating whether the game is to be continued is displayed. For example, when a “pass” button is operated, a pass request message appears (step SB8), and a user inputs a pass via the game device or the remote controller (step SB9). This pass is the cancel pass described in FIG. 4. If the cancel pass is proper, the play is continued (steps SB10 and SB11). If the cancel pass is not proper, the power is turned off and the game is ended (step SB12). When the “pass” button is not operated at the time when the setting time passes, a message indicating the end of the game is displayed (step SB5), and the message is erased after a certain period of time passes (step SB6), so that the game is ended.

As described above, with the television receiving apparatus 11, usage restriction information can be set for the connecting device 201a. When the connecting device 201a is used, an HDMI CEC command is utilized. That is to say, the device to be controlled is specified and the set control contents are executed by the CEC command.

With the above apparatus, for example, restriction information is used so that a plurality of game devices can only be used by their users. That is to say, a unique game device can be prevented from being used by other users.

Excessive use of the game device can also be restricted. For example, if the game device is used for too long a period of time by a child, the child's parents can restrict the usage time.

Further, the total usage time of a specific device can be managed. For example, the total usage time can be set for a DVD player, a movie camera or a game device which is rented from a rental shop or lent by a friend. In this case, a total usage time processing module can be further provided in the device managing module. When the total usage time is exceeded, a message is displayed.

In the management of the total time, the usage time for one week can be set to 10 hours. When the total time is reset, a password is input so that the reset is enabled.

The restriction information is input by the user, but default data may be stored in the restriction information storage module in advance.

In the above description, the operation monitoring module 232 controls the user managing module 233, for example, when the setting time as the restriction information is exceeded. The user managing module 233 displays a warning text, adjusts a screen (for example, adjusts deterioration of an image quality), and turns off the power. The power of either the external connection device or the television receiving apparatus may be turned off, or the power of both of them may be turned off.

The warning issued by the user managing module 233 is not limited to that in the above description, and can be given by various other means. For example, a sound message may be given or the volume of a sound may be reduced. Further, a sound and a warning text may be output together. As the screen adjustment, various warning formats, such as a change in color, a change in an image quality, or a reduction and an enlargement of an image can be provided.

In the warning format, a color of the screen may be changed (for example, the color of the entire screen is changed into yellow or black and white). Further, when the game device needs to save a program, contents which urge the user to save the program may be output as a warning text or a warning sound. A recommended save text may be such that “The power of the game device will be turned off . . . minutes later. Please save the program”. When the game device itself has an automatic saving function, a command for allowing the game device to execute the automatic saving function may be transmitted together with the warning text and the warning sound from the television receiving apparatus.

Further, the connected state between the television receiving apparatus and the game device may be controlled. For example, the setting of an input line of the television receiving apparatus may be switched and the connection with the game device may be cut. At this time, a message “the connection with the game device will be cut” may be displayed for a while. The television receiving apparatus may then be automatically switched into a broadcasting receiving state, for example.

As a method of warning, a sound in the game may be altered or muted. As described above, a game image of the television receiving apparatus may be in a still reproduction state, but in this case, a warning text and a warning sound are output simultaneously so that a current state such that restriction is imposed on the user becomes clear.

The above describes that the power of the television receiving apparatus or the game device is turned off. However, as to the television receiving apparatus, the power is once turned off, and after a certain time passes (for example, one hour passes), the power may be again turned on.

From a viewpoint of time management, total used time of the game device is managed, and when the setting time is exceeded, the restriction may be imposed. The restriction state may manage the elapsed time. A restriction such that the game device cannot be used until 10 hours, 24 hours or 48 hours pass after the start of the restriction state may also be imposed.

In the above description, a direct control signal to be an origin of a warning to the user is generated in the controller 23 of the television receiving apparatus. However, even when the operation is monitored by the television receiving apparatus 11, the direct control signal to be the origin of the warning to the user may be generated from the external connection device (in the above example, the game device).

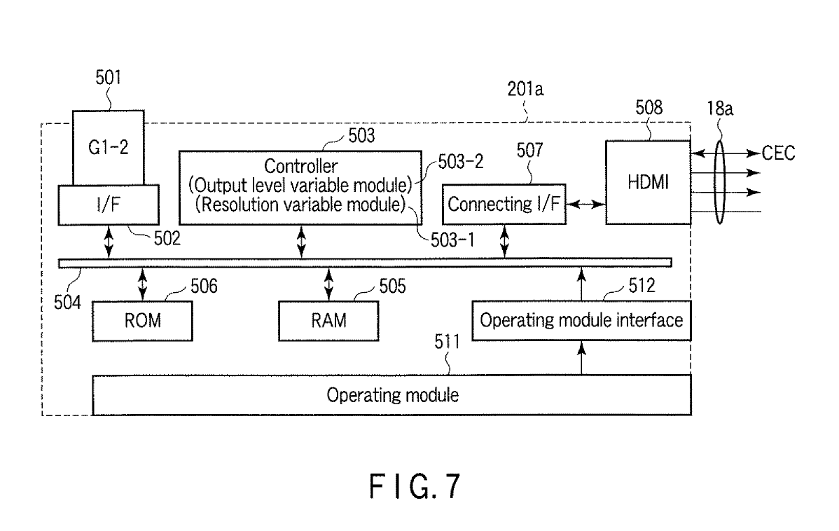

FIG. 7 illustrates a constitutional example of the game device 201a. In the game device 201a, for example, a memory card 501 can be attached to an interface 502. Game software of the memory card 501 is read by a controller 503 via a bus 504, and is developed in a RAM 505. Software for providing a basic operation of the controller 503 is stored, for example, in a ROM 506.

When the software in the RAM 505 is actuated, various image data stored in the memory card 501 are read so as to be transmitted to the television receiving apparatus 11 via a connecting interface 507 and an HDMI 508. Device identification information is also transmitted from the HDMI 508. When mutual authentication with respect to the television receiving apparatus 11 is performed, output of image data with resolution allowable in the television receiving apparatus 11 is prepared. Normally, the highest resolution allowable in the television receiving apparatus 11 is set.

When a game is started, the user operates an operating module 511 so that the game proceeds. An operation signal is interpreted by the controller 503 via an operation interface 512, and image and audio data are processed according to the operation signal.

In the television receiving apparatus 11, a determination is made that the operation is restricted. The CEC command representing the operation restriction is transmitted from the television receiving apparatus 11. As a result, the controller 503 analyzes contents of the CEC command, and outputs, for example, image data with varied resolutions. For example, the resolution may be varied sequentially to 1080P, 1080i, 720p, 480p and 480i. In another method, an audio output may be gradually reduced or off. Therefore, the controller 503 is provided with a resolution variable module 503-1 and an output level variable module 503-2. Further, the operation buttons of the operating module 511 are made to be non-responsive, or input of the operation buttons may be disabled.

While certain embodiments of the invention have been described, these embodiments have been presented by way of example only, and are not intended to limit the scope of the invention. Indeed, the novel methods and systems described herein may be embodied in a variety of forms; furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

What is claimed is:

1. A use status monitoring apparatus comprising:
a first apparatus configured to receive at least image data from a second apparatus, and to output an image of the image data to a display module;
a restriction information storage module provided to the first apparatus, configured to store restriction information relating to operating time or operating contents of the second apparatus;
an operation monitoring module provided to the first apparatus, configured to monitor the operating time or the operating contents based on the restriction information; and
a managing module provided to the first apparatus, configured to announce of restricting the operating time or the operating contents during the monitoring of the operation monitoring module.

2. The use status monitoring apparatus of claim 1, further comprising a restriction information adjusting module configure to display the restriction information on the display module and to change the restriction information.

3. The use status monitoring apparatus of claim 1, wherein the managing module includes a warning output module which, when the operating time or the operating contents are restricted, displays a warning on the display module.

4. The use status monitoring apparatus of claim 1, wherein the first apparatus and the second apparatus are connected based on a high definition multimedia interface (HDMI) standard.

5. The use status monitoring apparatus of claim 1, wherein the second apparatus is a game device.

6. A television receiving apparatus which has a display module for displaying an image based on a received broadcasting signal and is connected to an external connection device, comprising:
a restriction information storage module configured to store restriction information arbitrarily set relating to operating time or operating contents of the external connection device;
an operation monitoring module configured to monitor the operating time or the operating contents based on the restriction information; and
a managing module configured to announce of restricting the operating time and the operating contents during the monitoring of the operation monitoring module.

7. The television receiving apparatus of claim 6, further comprising a restriction information adjusting module configured to display the restriction information on the display module and changes the restriction information.

8. The television receiving apparatus of claim 6, wherein the managing module includes a warning output module which, when the operating time or the operating contents are restricted, displays a warning on the display module.

9. A method of monitoring a use status of an external connection apparatus in which a first apparatus connected to a second apparatus and a display module monitors a use status of the second apparatus, comprising:
storing arbitrarily set restriction information relating to operating time or operating contents of the second apparatus;
monitoring the operating time or the operating contents based on the restriction information; and
announcing of restricting the operating time or the operating contents during the monitoring.

10. The method of monitoring the use status of the external connection apparatus of claim 9, wherein the announcing is given by a method including any one of displaying a warning text on the display module, outputting a warning sound by means of audio output, varying a quality of an image displayed on the display module or turning off the power of the second apparatus.
